(19) United States
(12) Patent Application Publication
(10) Pub. No.: US 2026/0011457 A1
(43) Pub. Date: Jan. 8, 2026

(54) Fuel Assembly and Method for Producing Fuel Assembly

(71) Applicant: Hitachi GE Vernova Nuclear Energy, Ltd., Hitachi-shi (JP)

(72) Inventors: Ryo Ishibashi, Tokyo (JP); Katsuhito Takahashi, Tokyo (JP); Fuminori Iwamatsu, Tokyo (JP); Kenichi Yasuda, Ibaraki (JP); Yoshiharu Kikuchi, Ibaraki (JP); Keita Yoshida, Ibaraki (JP); Masana Sasaki, Ibaraki (JP); Masatoshi Shibata, Ibaraki (JP)

(21) Appl. No.: 19/252,773

(22) Filed: Jun. 27, 2025

(30) Foreign Application Priority Data
Jul. 2, 2024 (JP) 2024-106928

(51) Int. Cl. G21C 3/324; G21C 3/33; G21C 3/336; G21C 3/60; G21C 21/14

(52) U.S. Cl. CPC G21C 3/324; G21C 3/3305; G21C 3/3315; G21C 3/336; G21C 3/60; G21C 21/14

(57) ABSTRACT

The fuel assembly includes a base material formed of a zirconium alloy and a coating layer, and the coating layer includes a chromium layer formed of chromium or a chromium alloy and a corrosion-resistant layer formed of zirconium alloy or a titanium alloy. The method for producing a fuel assembly includes a step of preparing the base material, a step of forming the chromium layer on a surface of the base material that would otherwise be in contact with cooling water, a step of forming the corrosion-resistant layer on a surface of the chromium layer, and a step of assembling the fuel assembly using the base material. The chromium layer and the corrosion-resistant layer are formed according to a thin plate cladding method, a physical vapor deposition method, a thermal spraying method, a cold spraying method, or a plating method before the assembling using the base material.

### TECHNICAL FIELD

This application relates to and claims the benefit of priority from Japanese Patent Application No. 2024-106928 filed on Jul. 2, 2024, the entire disclosure of which is incorporated herein by reference.

The present invention relates to a fuel assembly for a water-cooled reactor using light water or the like as a cooling material, and a method for producing a fuel assembly for a water-cooled reactor.

### BACKGROUND ART

In a water-cooled reactor, water such as light water is used as a cooling material. Examples of the water-cooled reactor include a boiling water reactor (BWR) and a pressurized water reactor (PWR). In a water-cooled reactor, a zirconium alloy to which niobium, tin, iron, chromium, nickel, or the like is added has been used as a material for a reactor core structure from the viewpoint of obtaining a small thermal neutron absorption cross-section and excellent corrosion resistance.

In a serious accident of a water-cooled reactor, a material for a reactor core structure is exposed to a high-temperature oxidation environment in which high-temperature steam is present. Therefore, in recent years, for the purpose of increasing resistance in a high-temperature oxidation environment, chromium coating on a zirconium alloy member constituting a fuel assembly of a reactor core has been studied. This is a technique of coating a surface of a base material formed of a zirconium alloy with chromium or a chromium compound such as an oxide, a nitride, or a carbide to prevent oxidation of the base material and generation of hydrogen at a high temperature.

A fuel assembly is loaded in a reactor core of a light water reactor such as a BWR or a PWR. The fuel assembly is a structure in which a plurality of fuel rods loaded with fuel pellets are aligned and supported by an upper tie plate and a lower tie plate. In the fuel assembly of the BWR, the aligned fuel rods are surrounded by a channel box from the outside. The channel box has a function of rectifying cooling water and a function of preventing a control rod movable outside from coming into contact with the fuel rod.

The fuel rod is a component obtained by stacking and loading a plurality of fuel pellets in a fuel cladding tube having a length of about 4 m. Both ends of the fuel rod are sealed by end plugs. As a material for the fuel cladding tube and the end plug, a zirconium alloy having a small thermal neutron absorption cross-section and excellent corrosion resistance has already used. Therefore, the fuel cladding tube and the end plug forming the fuel rod have been excellent in neutron economy and have been safely used in a furnace environment during normal operation of the nuclear reactor.

The channel box is a tubular component having a rectangular shape in a top view, and is provided in a structure surrounding the fuel rods arranged in a matrix. The channel box is in contact with outer peripheral surfaces of the upper tie plate and the lower tie plate and is supported by the upper tie plate. As the material for the channel box, a zirconium alloy is used similarly to the fuel cladding tube and the end plug.

In a water-cooled reactor, when a loss-of-coolant accident occurs, the temperature in the nuclear reactor rises due to heat generation of nuclear fuel, so that high-temperature steam is generated in the nuclear reactor. When an amount of the cooling water decreases and the fuel rod is exposed, a temperature of the fuel rod rises to 1000° C. or higher, and a reaction between the zirconium alloy forming the fuel rod and steam occurs. Hydrogen generated by the oxidation-reduction reaction between zirconium and water may cause an explosion accident. Generation of a large amount of hydrogen due to the oxidation of zirconium is an event that needs to be strictly avoided.

Recent nuclear reactors are provided with multiple emergency equipment such as an emergency power supply and an emergency reactor core cooling device in order to prevent a loss-of-coolant accident and an explosion accident. System design with enhanced safety has been performed, and further improvements and modifications in emergency equipment have been made.

For example, it is defined that an emergency reactor core cooling system needs to have a performance of converging an accident while maintaining a coolable shape of a fuel assembly during a loss-of-coolant accident. The evaluation guidelines for the performance include maintaining the maximum high temperature of the fuel cladding tube at 1200° C. or lower, maintaining the oxidation amount of the fuel cladding tube at 15% or less before the oxidation reaction is remarkable, maintaining an amount of hydrogen generated by a structure inside the reactor at a sufficiently low value from the viewpoint of ensuring the soundness of a storage container, and continuing removal of decay heat for a long time even in consideration of the change in the shape of the nuclear fuel.

In the field of design and evaluation of nuclear facilities, an accident that progresses under a predetermined criterion assumed for setting and evaluating design conditions is referred to as a design basis accident (DBA). The system design that meets certain standards for DBA is performed on nuclear facilities. On the other hand, a serious accident beyond DBA is called beyond design basis accident (BDBA). In recent years, efforts have been made to strengthen safety in both software and hardware aspects in preparation for the occurrence of a BDBA.

Enhancement of safety has been promoted not only for the system design but also for materials for reactor core structures. For the DBA, a material that reduces the amount of hydrogen generated by an oxidation-reduction reaction with water and a material for preventing leakage of fission products have been studied. For the BDBA in which the temperature of the reactor core structure exceeds 1200° C., a material for reducing the amount of hydrogen generated by increasing the oxidation resistance at a high temperature and a material for reducing a temperature rise rate have been studied.

For example, as a material for the fuel cladding tube or the end plug, the use of Al-containing stainless steel or ceramics such as silicon carbide having excellent oxidation resistance instead of a zirconium alloy has been studied. The use of ceramics such as silicon carbide as a material for the channel box has been studied. A method of coating the surface of a zirconium alloy has been studied. There is a technique for forming a coating film for increasing oxidation resistance at a high temperature on a zirconium alloy which has been abundant in actual results in an actual furnace and for which data for regulation has been prepared.

Examples of a technique for forming a coating film include a chromium coating for coating chromium on the surface of the zirconium alloy. When the zirconium alloy forming the fuel cladding tube is coated with chromium, oxidation resistance at a high temperature is improved, so that generation of hydrogen due to an oxidation-reduction reaction with cooling water can be reduced. Further, chromium has a high-temperature strength higher than a zirconium alloy, and therefore, deformation of the zirconium alloy member coated with chromium at a high temperature is prevented. The opening of the fuel cladding tube during ballooning or rupture is reduced, and therefore, it is expected that blocking of a coolant flow path, oxidation inside the fuel cladding tube, exposure of the fuel pellets, and the like are prevented.

JP2015-523231A describes a multilayer material that is a material used in the field of nuclear power and includes a zirconium-based substrate covered with a multilayer coating. The multilayer coating includes a layer of metal selected from chromium, a chromium alloy, or a ternary alloy of Nb—Cr—Ti. The layer made of the ternary alloy of Nb—Cr—Ti is provided between the substrate and the layer made of chromium or a chromium alloy, and the like.

### SUMMARY OF INVENTION

### Technical Problem

The chromium layer formed by chromium coating has excellent oxidation resistance at a high temperature, but corrosion is likely to proceed in a water environment during normal operation of a nuclear reactor in which a corrosion potential is high, and it is necessary to pay attention to corrosion resistance. Chromium forms an oxide or an oxyhydroxide in a water environment in which water is present. Oxides and oxyhydroxides of chromium are likely to be dissolved in a water environment having a high dissolved oxygen concentration or a high hydrogen peroxide concentration and a high corrosion potential, and therefore, there is a problem that the function of a protective film is likely to be weakened.

The coated chromium is eluted into the cooling water as chromate ions. The chromate ions affect electric conductivity, an impurity concentration, and the like of the cooling water, and therefore, there is a possibility that the chromate ions affect water chemistry management of the cooling water and control of the nuclear reactor. When a chromium acid concentration of the cooling water increases, there is a problem that the load on a purification system of the nuclear reactor increases.

Chromium is a material in which the thermal neutron absorption cross-section is about 15 times that of zirconium and absorption of thermal neutrons is large. When the reactor core structure is coated with chromium, a chromium layer as thin as possible needs to be formed from the viewpoint of neutron economy. On the other hand, when the chromium layer is too thin, the chromium layer is likely to disappear when chromium is eluted into the cooling water. When the chromium layer disappears, there is a problem that an action of increasing oxidation resistance at a high temperature, an action of preventing deformation of a material under a high temperature, and the like are lost.

The chromium layer formed by chromium coating is provided in a state of being adjacent to another layer such as a base material formed of a zirconium alloy. When the chromium layer is exposed to a high temperature during an accident of a nuclear reactor, interdiffusion of atoms between the chromium layer and another adjacent layer progresses. The oxidation proceeds from a surface side in contact with the cooling water. When the diffusion of a hetero atom proceeds in the chromium layer, a melting point of the chromium layer may decrease. At a high temperature in an accident of the nuclear reactor, melting may proceed from a region having a low melting point, and the chromium layer may eventually disappear.

Under such circumstances, there is a demand for a technique that achieves both oxidation resistance at a high temperature during an accident of a nuclear reactor and corrosion resistance in a water environment where the chromium layer is in contact with cooling water during normal operation of the nuclear reactor. Regarding the chromium layer formed by chromium coating, it is desired to prevent the elution of chromium to the minimum and ensure appropriate neutron economy and the function of a protective film. It is desired to prevent interdiffusion of atoms at a high temperature during an accident of a nuclear reactor r to prevent melting and disappearance of the chromium layer.

In JP2015-523231A, the layer made of a ternary alloy of Nb—Cr—Ti is formed in addition to the chromium layer made of chromium or a chromium alloy. However, the ternary alloy of Nb—Cr—Ti contains niobium at an atomic percentage of 50% to 75%. The ternary alloy of Nb—Cr—Ti containing niobium as a main component may generate a niobium oxide in a water environment where the layer is in contact with cooling water. The niobium oxide has solubility, and therefore, it is difficult to ensure the function of a protective film for a long period of time.

In JP2015-523231A, a multilayer coating in which a large number of thin metal layers are laminated is formed. With such a structure, a distance between the layer made of chromium or a chromium alloy and the layer made of a ternary alloy of Nb—Cr—Ti is reduced, and therefore, there is a problem that interdiffusion of atoms easily proceeds at a high temperature. Due to the progress of interdiffusion of atoms between adjacent layers, the chromium layer may melt or disappear.

Therefore, an object of the invention is to provide a fuel assembly including a coating layer that achieves both oxidation resistance at a high temperature during an accident of a nuclear reactor and corrosion resistance in a water environment where the coating layer is in contact with cooling water during normal operation of the nuclear reactor, and a method for producing a fuel assembly.

### Solution to Problem

In order to solve the above problem, a fuel assembly according to the invention is a fuel assembly for a water-cooled reactor, and includes a base material formed of a zirconium alloy, and a coating layer formed on the base material. The coating layer includes a chromium layer formed of chromium or a chromium alloy on a surface of the base material that would otherwise be in contact with cooling water.

A method for producing a fuel assembly according to the invention is a method for producing a fuel assembly for a water-cooled reactor, and the method includes a step of preparing a base material formed of a zirconium alloy, a step of forming a chromium layer by chromium or a chromium alloy on a surface of the base material that would otherwise be in contact with cooling water, a step of forming a corrosion-resistant layer by a zirconium alloy or a titanium alloy on a surface of the chromium layer, and a step of assembling the fuel assembly using the base material. The chromium layer and the corrosion-resistant layer are formed according to a thin plate cladding method in which thin plates are stacked and diffusion-joined, a physical vapor deposition method, a thermal spraying method, a cold spraying method, or a plating method before the assembling using the base material.

### Advantageous Effects of Invention

The invention can provide a fuel assembly including a coating that achieves both oxidation resistance at a high temperature during an accident of a nuclear reactor and corrosion resistance in a water environment where the coating is in contact with cooling water during normal operation of the nuclear reactor, and a method for producing the fuel assembly.

### BRIEF DESCRIPTION OF DRAWINGS

FIG. 1 is a diagram schematically showing an example of a coating structure formed on a surface of a fuel assembly according to an embodiment of the invention.

FIG. 2 is a diagram schematically showing an example of a coating structure formed on a surface of a fuel assembly according to the embodiment of the invention.

FIG. 3 is a longitudinal-sectional view showing an example of a fuel assembly for a BWR.

FIG. 4 is a cross-sectional view showing an example of the fuel assembly for the BWR.

FIG. 5 is a longitudinal-sectional view showing an example of a fuel rod.

FIG. 6 is a partial cross-sectional view showing an example of a water rod.

FIG. 7 is a perspective view showing an example of a channel box.

FIG. 8 is a diagram showing a method for producing the channel box.

FIG. 9 is a perspective view showing an example of a fuel assembly for a PWR.

### DESCRIPTION OF EMBODIMENTS

Hereinafter, a fuel assembly and a method for producing the fuel assembly according to an embodiment of the invention will be described with reference to the drawings. The same components are denoted by the same reference numerals in the following drawings, and repeated description will be omitted.

In the present description, formation of a layer on a surface means formation of the layer at a position where the layer covers a base material and another layer from the outside. Each layer may be directly laminated on a surface of the base material or another layer, or may be laminated above the surface of the base material or another layer with another layer interposed therebetween. Each layer may be formed by a film forming method such as a physical vapor deposition method, a thermal spraying method, a cold spraying method, or a plating method, or may be formed by bonding according to a thin plate cladding method.

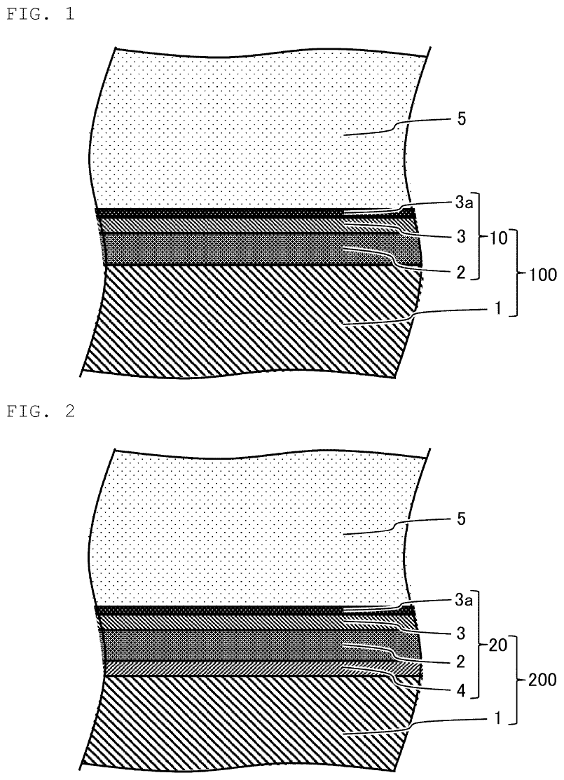

FIG. 1 is a diagram schematically showing an example of a coating structure formed on a surface of a fuel assembly according to an embodiment of the invention. FIG. 1 shows a structure in which a coating layer having a two-layer structure is formed on a base material forming a fuel assembly. As shown in FIG. 1, a coating structure 100 including a coating layer 10 having a two-layer structure can be formed on the surface of the fuel assembly according to the present embodiment. The coating structure 100 includes a base material 1 formed of a zirconium alloy and the coating layer 10 having a two-layer structure formed on the base material 1.

In FIG. 1, the coating layer 10 includes a chromium layer 2, a corrosion-resistant layer 3, and an oxide film 3a. The chromium layer 2 is formed on a surface of the base material 1 formed of a zirconium alloy. The corrosion-resistant layer 3 is formed on a surface of the chromium layer 2. The oxide film 3a is formed on a surface of the corrosion-resistant layer 3. The coating layer 10 is in contact with cooling water 5 of a nuclear reactor on a surface opposite to an interface in contact with the base material 1.

The coating structure 100 is formed at least in a region of the surface of the fuel assembly for a water-cooled reactor, and the region comes into contact with the cooling water 5 of the nuclear reactor. The coating structure 100 is preferably formed in a region that comes into contact with high-temperature steam in an accident of a nuclear reactor. Examples of the water-cooled reactor include a boiling water reactor (BWR), a pressurized water reactor (PWR), an advanced boiling water reactor (ABWR), and a pressurized heavy water reactor (PHWR).

The coating layer 10 is in contact with the cooling water 5 of the nuclear reactor. The coating layer 10 is exposed to an operation environment during normal operation of the nuclear reactor, and is exposed to an accident environment during an accident of the nuclear reactor. For example, the operation environment in the BWR is an environment where the coating layer 10 is in contact with a single-phase flow of pure water at around 290° C. or a two-phase flow of high-temperature pure water and steam. The operation environment in the PWR is an environment where the coating layer 10 is in contact with a single-phase flow of water containing boron or lithium at around 325° C. The accident environment is an environment where the coating layer 10 is in contact with a single-phase flow of steam at about 700° C. to 1200° C. or higher.

The base material 1 is a structural material or the like that forms the fuel assembly for the water-cooled reactor. The base material 1 is formed of a zirconium alloy containing zirconium as a main component. The zirconium alloy forming the base material 1 is an alloy having a material structure adjusted by addition of an alloy component and heat treatment for use in the nuclear reactor.

Examples of the zirconium alloy include an alloy recontaining one or more alloy elements of niobium, tin, iron, chromium, and nickel at a concentration of 3 mass % or less, with the balance being zirconium and inevitable impurities. Specific examples of the zirconium alloy include zircaloy-2, zircaloy-4, a zirconium-niobium-tin alloy, and a zirconium-niobium alloy.

Zircaloy-2 contains, by mass %, tin of 1.20% to 1.70%, iron of 0.07% to 0.20%, chromium of 0.05% to 1.15%, and nickel of 0.03% to 0.08%, with the balance being zirconium and inevitable impurities. Zircaloy-2 may contain 900 to 1500 ppm of oxygen.

Zircaloy-4 contains, by mass %, tin of 1.20% to 1.70%, iron of 0.18% to 0.24%, and chromium of 0.07% to 1.13%, nickel of less than 0.0078, with the balance being zirconium and inevitable impurities. Zircaloy-4 may contain 900 to 1500 ppm of oxygen.

The zirconium-niobium-tin alloy contains niobium of 0.5% to 2.0%, tin of 0.7% to 1.5%, and one or more elements, selected from the group consisting of iron, nickel, and chromium, of 0.07% to 0.42%, with the balance being zirconium and inevitable impurities. The zirconium-niobium-tin alloy may contain 200 ppm or less of oxygen.

The zirconium-niobium alloy contains niobium of 0.8% to 1.2%, with the balance being zirconium and inevitable impurities. The zirconium-niobium alloy may contain 900 ppm to 1490 ppm of oxygen.

The chromium layer 2 is a layer containing chromium as a main component and is formed of chromium or a chromium alloy. The chromium layer 2 is formed on a surface of the base material 1 that would otherwise be in contact with the cooling water 5. With the chromium layer 2, oxidation resistance at a high temperature is increased. Therefore, even when the chromium layer 2 is exposed to an accident environment which is a high-temperature oxidation environment where high-temperature steam is present, the base material 1 can be protected by preventing elution of zirconium forming the base material 1 and generation of hydrogen. In addition, wear resistance is increased. With chromium or a chromium alloy, unlike the case of a chromium compound, a stable protective film can be formed because no gas is generated due to corrosion or radiatization.

The chromium layer 2 may contain a component diffused from the base material 1 or the corrosion-resistant layer 3 adjacent to the chromium layer 2, or the like. The chromium layer 2 may contain one or more of niobium, tin, iron, chromium, nickel, zirconium, titanium, and inevitable impurities diffused from a layer adjacent to the chromium layer 2. Examples of the inevitable impurities include hafnium, nitrogen, and carbon that are inevitably mixed during the production of the base material 1 and during the formation of the corrosion-resistant layer 3.

The thickness of the chromium layer 2 is preferably 5 μm or more and 1/31 or less of a thickness of the base material 1, and more preferably 5 μm or more and 50 μm or less. When the thickness is 5 μm or more, the function of the chromium layer 2 can be ensured even if atoms are diffused from another adjacent layer in an accident environment or the like. When the thickness is 1/31 or less of the thickness of the base material 1, a thermal neutron absorption cross-section by the chromium layer 2 is twice or less a thermal neutron absorption cross-section by the base material 1. Chromium has a thermal neutron absorption cross-section larger than zirconium, and is a material disadvantageous in terms of neutron economy. However, when the thickness of the chromium layer 2 is limited, the influence of the absorption of neutrons on the reactor core design can be reduced while increasing the oxidation resistance and the like at a high temperature.

The corrosion-resistant layer 3 is a layer containing zirconium or titanium as a main component, and is formed of a zirconium alloy or a titanium alloy. The corrosion-resistant layer 3 is formed on the surface of the chromium layer 2. On the surface of the corrosion-resistant layer 3 in contact with the cooling water 5, the oxide film 3a is formed of zirconium oxide or titanium oxide generated by oxidation of the corrosion-resistant layer 3. With the corrosion-resistant layer 3, the corrosion resistance is increased, and therefore, elution of chromium forming the chromium layer 2 or disappearance of the chromium layer 2 can be prevented to protect the base material 1 or the chromium layer 2 even when the corrosion-resistant layer 3 is exposed to an operation environment where the dissolved oxygen concentration or the hydrogen peroxide concentration is high and the corrosion potential is high.

The corrosion-resistant layer 3 can be formed of a zirconium alloy containing one or more alloy elements of niobium, tin, iron, chromium, and nickel at a concentration of 3 mass % or less, with the balance being zirconium and inevitable impurities, a titanium alloy containing one or more alloy elements of niobium, tin, iron, chromium, and nickel at a concentration of 3 mass % or less, with the balance being titanium and inevitable impurities, or a zirconium-titanium alloy containing these alloy elements. When the concentration of the alloy element is too high, the corrosion resistance of the corrosion-resistant layer 3 itself is impaired. When the alloy element is 3 mass % or less, high corrosion resistance can be ensured.

In the corrosion-resistant layer 3, the concentration of zirconium and the concentration of titanium can be set to any ratio. The corrosion-resistant layer 3 may have a concentration gradient in which the concentration of components in each region is inclined inside the corrosion-resistant layer 3. For example, a concentration gradient in which a concentration of chromium decreases, and a concentration of zirconium or titanium increases from an interface in contact with the chromium layer 2 to an interface on the opposite side can be formed. When such a concentration gradient is formed, adhesion between layers and corrosion resistance can be increased.

The corrosion-resistant layer 3 may contain a component diffused from the chromium layer 2 or the like adjacent to the corrosion-resistant layer 3. The corrosion-resistant layer 3 may contain one or more of niobium, tin, iron, chromium, nickel, zirconium, titanium, and inevitable impurities diffused from a layer adjacent to the corrosion-resistant layer 3. Examples of the inevitable impurities include hafnium, aluminum, zinc, and the like that are inevitably mixed during the production of the base material 1 and during the formation of the chromium layer 2.

The corrosion-resistant layer 3 may have a region containing chromium diffused from the chromium layer 2 at a concentration of 3 mass % or more. At a high temperature or the like during an accident of a nuclear reactor, interdiffusion of atoms may proceed between the chromium layer 2 and the corrosion-resistant layer 3. Even in such a case, the formation of the oxide film 3a can increase the corrosion resistance in the water environment where the corrosion-resistant layer 3 is in contact with the cooling water during the normal operation of the reactor.

A thickness of the corrosion-resistant layer 3 is preferably a thickness of 5 μm or more, and an atomic concentration ratio of zirconium or titanium to chromium in the total of the chromium layer 2 and the corrosion-resistant layer 3 is preferably equal to or less than a predetermined value. When the thickness is 5 μm or more, the function of the corrosion-resistant layer 3 can be ensured even if atoms diffuse from the chromium layer 2 or the like adjacent to the corrosion-resistant layer 3.

In the coating layer 10, when the corrosion-resistant layer 3 is formed of a zirconium alloy, a ratio of an atomic concentration of zirconium to an atomic concentration of chromium in the total of the chromium layer 2 and the corrosion-resistant layer 3 is preferably 3/2 or less. When the corrosion-resistant layer 3 is formed of a titanium alloy, a ratio of an atomic concentration of titanium to an atomic concentration of chromium in the total of the chromium layer 2 and the corrosion-resistant layer 3 is preferably 1 or less. With such an atomic concentration ratio, the melting point of the chromium layer 2 can be ensured at a high temperature.

During an accident of a nuclear reactor, in addition to the cooling water 5 of the nuclear reactor, the base material 1 and the coating layer 10 also have a high temperature. Interdiffusion of atoms between the corrosion-resistant layer 3 and the chromium layer 2 or the like proceeds, and oxidation proceeds from a surface side in contact with the cooling water 5. The melting point of elemental chromium is 1855° C. When chromium is alloyed with zirconium or titanium, the melting point decreases to 1322° C. or 1410° C., respectively. When oxygen is contained, the melting point is further decreased. In contrast, when the atomic concentration ratio of the coating layer 10 is limited, the melting point of the chromium layer 2 is ensured at a high temperature. Even if the chromium layer 2 is locally melted during an accident of a nuclear reactor, a sufficient margin is obtained until the entire chromium layer 2 is melted and disappears. Therefore, the function of the chromium layer 2 can be ensured.

According to such a coating structure 100, high oxidation resistance is obtained due to the chromium layer 2 in an accident environment which is a high-temperature oxidation environment where high-temperature steam is present during an accident of a nuclear reactor. In addition, high corrosion resistance is obtained due to the corrosion-resistant layer 3 in an operation environment in which the dissolved oxygen concentration and the hydrogen peroxide concentration are high and the corrosion potential is high during normal operation of a nuclear reactor. That is, it is possible to achieve both oxidation resistance at a high temperature during an accident of a nuclear reactor and corrosion resistance in a water environment where the coating layer 10 is in contact with cooling water during normal operation of the nuclear reactor. Elution of chromium and disappearance of the chromium layer are prevented, and the base material 1 and the like are protected by improving the oxidation resistance and the corrosion resistance. Therefore, safety during an accident is improved. It is possible to reduce the deterioration in the coating structure and the load on the purification system during normal operation while ensuring the soundness of the fuel assembly during an accident of a nuclear reactor.

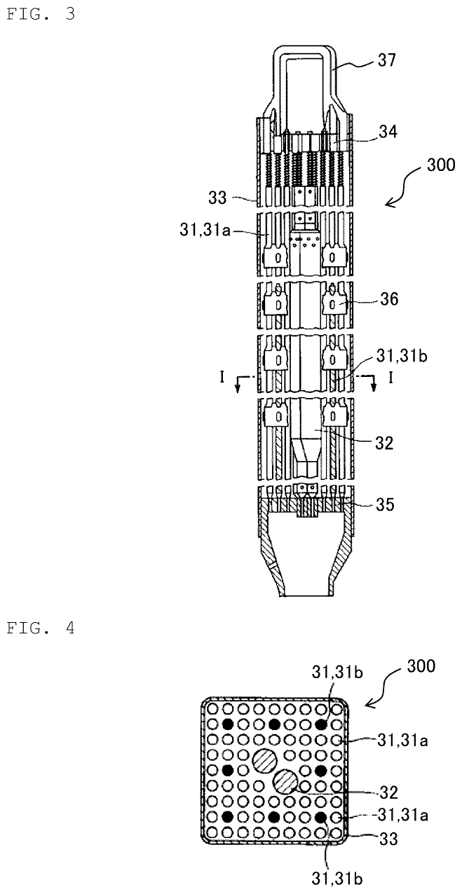

FIG. 2 is a diagram schematically showing an example of a coating structure formed on a surface of the fuel assembly according to the embodiment of the invention. FIG. 2 shows a structure in which a coating layer having a three-layer structure is formed on a base material forming the fuel assembly. As shown in FIG. 2, a coating structure 200 including a coating layer 20 having a three-layer structure can also be formed on the surface of the fuel assembly according to the present embodiment. The coating structure 200 includes the base material 1 formed of a zirconium alloy and the coating layer 20 that has a three-layer structure and is formed on the base material 1.

In FIG. 2, the coating layer 20 includes an isolation layer 4, the chromium layer 2, the corrosion-resistant layer 3, and the oxide film 3a. The isolation layer 4 is formed on a surface of the base material 1 formed of a zirconium alloy. The chromium layer 2 is formed on a surface of the isolation layer 4. The corrosion-resistant layer 3 is formed on a surface of the chromium layer 2. The oxide film 3a is formed on a surface of the corrosion-resistant layer 3. The coating layer 20 is in contact with cooling water 5 of a nuclear reactor on a surface opposite to an interface in contact with the base material 1.

Similarly to the coating structure 100, the coating structure 200 is formed at least in a region of the surface of the fuel assembly for the water-cooled reactor, and the region comes into contact with the cooling water 5 of the nuclear reactor. The coating structure 200 is preferably formed in a region that comes into contact with high-temperature steam in an accident of a nuclear reactor. The coating layer 20 is in contact with the cooling water 5 of the nuclear reactor. The coating layer 20 is exposed to an operation environment during normal operation of the nuclear reactor, and is exposed to an accident environment during an accident of the nuclear reactor.

The isolation layer 4 is a layer containing niobium or titanium as a main component, and is formed of niobium or titanium. The isolation layer 4 is formed on the surface of the base material 1 between the base material 1 and the chromium layer 2. With the isolation layer 4, diffusion of atoms between the base material 1 and the chromium layer 2 is prevented, so that a decrease in the melting point of the chromium layer 2 can be prevented. The melting or disappearance of the chromium layer 2 is reduced during an accident of a nuclear reactor, and therefore, the function of the chromium layer 2 can be ensured.

The isolation layer 4 may contain a component diffused from the base material 1, the chromium layer 2 adjacent to the isolation layer 4, or the like. The isolation layer 4 may contain one or more of niobium, tin, iron, chromium, nickel, zirconium, titanium, and inevitable impurities diffused from a layer adjacent to the isolation layer 4. Examples of the inevitable impurities include hafnium, aluminum, zinc, and the like that are inevitably mixed during the production of the base material 1 and during the formation of the chromium layer 2.

A thickness of the isolation layer 4 is preferably 1 μm or more and 20 μm or less. When the thickness is 1 μm or more, diffusion of atoms between the base material 1 and the chromium layer 2 can be sufficiently prevented. When the thickness is 20 μm or less, absorption of thermal neutrons by the isolation layer 4 is reduced. Niobium and titanium have an thermal neutron absorption cross-section larger than zirconium, and are disadvantageous materials in terms of neutron economy. However, when the thickness of the isolation layer 4 is limited, the influence on the reactor core design can be prevented. In addition, the chromium layer 2, the corrosion-resistant layer 3, and the like can be provided thicker by that amount.

With such a coating structure 200, similarly to the coating structure 100, it is possible to achieve both oxidation resistance at a high temperature during an accident of the nuclear reactor and corrosion resistance in a water environment where the coating layer 20 is in contact with cooling water during normal operation of the nuclear reactor. In addition, with the isolation layer 4, diffusion of atoms between the base material 1 and the chromium layer 2 is prevented, and a decrease in the melting point of the chromium layer 2 is prevented. When the temperature of the base material 1 or the chromium layer 2 rises during an accident of the nuclear reactor, diffusion of atoms between the base material 1 and the chromium layer 2 proceeds. The chromium layer 2 starts to melt at 1322° C. On the other hand, when the isolation layer 4 is provided, a melting start temperature of the chromium layer 2 can be raised to 1410° C. to 1620° c. During an accident of the nuclear reactor, melting and disappearance of the chromium layer 2 are prevented, and the base material 1 and the like are protected, so that safety during an accident is increased. It is possible to reduce the deterioration in the coating structure and the load on the purification system during normal operation while ensuring the soundness of the fuel assembly during an accident of a nuclear reactor.

Next, a method for producing a fuel assembly according to the present embodiment in which the coating structure 100, 200 is formed will be described.

The fuel assembly according to the present embodiment can be produced by forming the coating layer 10, 20 on the surface of the base material 1 before assembling the fuel assembly. The method for producing a fuel assembly according to the present embodiment includes a step of preparing a base material formed of a zirconium alloy, a step of forming a coating layer on a surface of the base material that would otherwise be in contact with cooling water, and a step of assembling a fuel assembly using the base material on which the coating layer is formed.

The step of forming the coating layer includes a step of forming a chromium layer by chromium or a chromium alloy on the surface of the base material that would otherwise be in contact with the cooling water, a step of forming a corrosion-resistant layer of a zirconium alloy or a titanium alloy on a surface of the chromium layer, and a step of forming an oxide film on a surface of the corrosion-resistant layer to be in contact with the cooling water. When the isolation layer is formed between the base material and the chromium layer, a step of forming the isolation layer by niobium or titanium on the surface of the base material that would otherwise be in contact with the cooling water is performed before the step of forming the chromium layer.

In the step of preparing the base material, a base material formed of a zirconium alloy is prepared as a structural material or the like for forming the fuel assembly. As the base material, as will be described below, a pipe material for forming a fuel cladding tube or thimble, a plate material for forming a channel box, a perforated water rod, a molded end plug, a molded support lattice, and the like can be prepared. The base material may be a primarily processed material such as a pipe material or a plate material, or may be a secondarily processed material obtained by performing bending processing, sleeve processing, or the like on the primarily processed material. The surface of the base material to be in contact with the cooling water is preferably subjected to degreasing treatment, pickling treatment, polishing treatment, or the like before the coating layer is formed.

The chromium layer, the corrosion-resistant layer, and the isolation layer constituting the coating layer can be formed according to a thin plate cladding method in which thin plates are stacked and diffusion-joined, a physical vapor deposition (PVD) method, a thermal spraying method in which a metal or the like is melted and sprayed, a cold spraying method in which a metal or the like is accelerated at a temperature lower than the melting point and sprayed, or the like.

The chromium layer can also be formed by a plating method such as electrolytic plating or electroless plating. On the other hand, the corrosion-resistant layer and the isolation layer are formed of zirconium, titanium, or niobium, and therefore, it is impossible to perform coating by electrolytic plating using a plating solution containing water as a solvent. Therefore, for the corrosion-resistant layer and the isolation layer, coating is performed according to a thin plate cladding method, a physical vapor deposition method, a thermal spraying method, or a cold spraying method.

After forming each layer constituting the coating layer, the formed layer can be subjected to heat treatment for the purpose of improving adhesion between the layers, removing strain, and the like. When the method for forming each layer involves heating or when the formed layer is subjected to the heat treatment, diffusion of atoms proceeds due to an increase in temperature, and therefore each layer contains a component diffused from a layer adjacent to each layer. Each layer may contain a component different from the fed component, or an interface with another layer may be unclear.

The step of forming the coating layer is performed after preparing the base material and before assembling the fuel assembly using the base material. For example, for the fuel cladding tube, the step of forming the coating layer may be performed before the end plug is welded, or may be performed after the end plug is welded to one end. For the water rod, the step of forming the coating layer may be performed before the end plug is welded, or may be performed after the end plug is welded to one end or both ends. For the thimble, the step of forming the coating layer may be performed before welding to a nozzle or after welding to the nozzle. For the channel box, the step of forming the coating layer is preferably formed before members subjected to bending processing are joined to each other. For the end plug, the step of forming the coating layer is collectively performed after welding when the end plug is welded to one end of the fuel cladding tube, or one end or both ends of the water rod. When the end plug is welded to the other end of the fuel cladding tube with one end to which the end plug is welded, the step of forming the coating layer is preferably performed individually before welding to the other end. The support lattice is preferably formed after the lattice is formed.

However, the coating layer may also be additionally formed on a local region after assembling the fuel assembly using the base material. For example, the coating layer can be formed by a thermal spraying method, a cold spraying method, or the like on a surface of a joint portion where base materials are joined by welding or the like. Specific examples of such a joint portion include a joint portion between the fuel cladding tube or the water rod and the end plug, a joint portion between the thimble and the nozzle or the support lattice, and a joint portion between members forming the channel box.

The oxide film on the surface of the corrosion-resistant layer can be formed by exposing the corrosion-resistant layer to high-temperature water or high-temperature steam under no irradiation with radiation after assembling the fuel assembly using the base material and before using the fuel assembly. The exposure to high-temperature water or high-temperature steam is preferably performed by pressurizing the atmosphere in which the base material is exposed to a high pressure equal to or higher than atmospheric pressure. The exposure to high-temperature water or high-temperature steam can be performed using an autoclave.

The temperature of the high-temperature water or high-temperature steam is preferably 100 r higher, more preferably 150° C. or higher, and still more preferably 200° C. or higher from the viewpoint of shortening the time required for forming an oxide film. From the viewpoint of forming a dense non-porous oxide film, the temperature is preferably 400° C. or lower, and more preferably 340° C. or lower. The pressure of the atmosphere is preferably 150 atm or less, and is preferably 10 atm or less at 400° C. from the viewpoint of forming a dense oxide film. The time of the exposure to the high-temperature water or the high-temperature steam can be freely set according to the temperature condition, the pressure condition, the target thickness of the oxide film, and the like. As the high-temperature water or the high-temperature steam, the high-temperature water having a temperature higher than room temperature (5° C. to 35° C.) or high-temperature steam having a temperature higher than 100° C. can be used depending on the exposure time or the like.

With such a production method, the step of forming the coating layer is performed before assembling the fuel assembly using the base material, and therefore, the coating layer can be easily formed on the base material forming the fuel assembly. Even when the region to be in contact with the cooling water is inside the structural material or the like forming the fuel assembly or is a region covered with another component, a layer having high uniformity in composition and thickness can be formed. Therefore, it is possible to stably produce a fuel assembly including a coating that achieves both oxidation resistance at a high temperature during an accident of the nuclear reactor and corrosion resistance in a water environment in which the fuel assembly is in contact with cooling water during normal operation of the nuclear reactor.

Next, an example of a specific structure of the fuel assembly according to the present embodiment to which the coating structure 100, 200 is applied will be described.

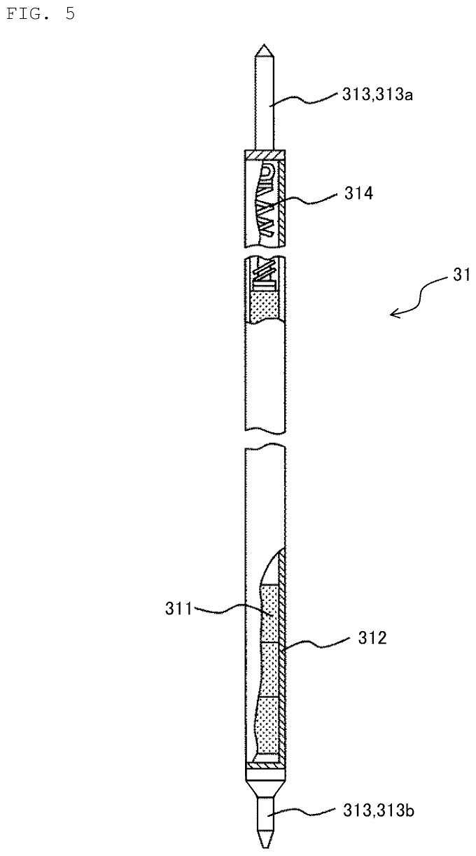

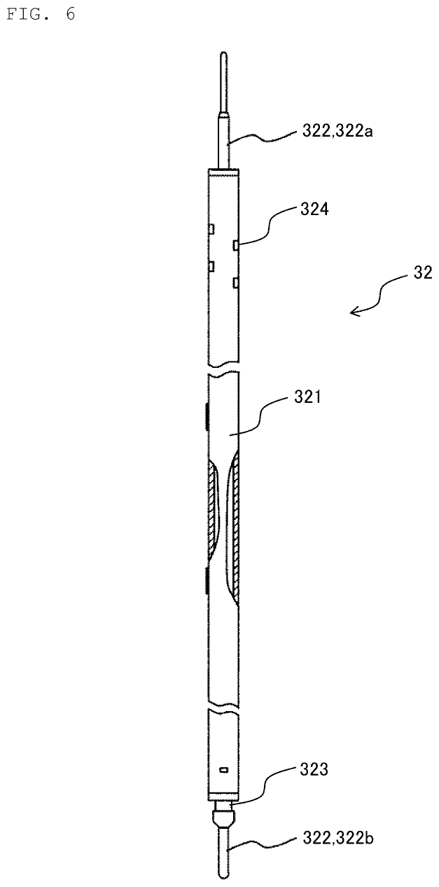

FIG. 3 is a longitudinal-sectional view showing an example of a fuel assembly for a BWR. FIG. 4 is a cross-sectional view showing an example of the fuel assembly for the BWR. FIG. 4 corresponds to a cross-sectional view taken along a line I-I in FIG. 3. As shown in FIGS. 3 and 4, a fuel assembly 300 for the BWR includes a plurality of fuel rods 31, a water rod 32, a channel box 33, an upper tie plate 34, a lower tie plate 35, a plurality of spacers 36, and a handle 37.

The fuel assembly 300 is a structure in which the plurality of fuel rods 31 are bundled, and is loaded in a reactor core of a boiling water reactor (BWR). In the BWR, four fuel assemblies 300 are loaded in a 2×2 lattice-shaped arrangement. A cross-shaped control rod in a top view is inserted between the fuel assemblies 300 so as to be movable in a vertical direction.

The fuel rod 31 is formed by loading fuel pellets obtained by molding nuclear fuel into a fuel cladding tube and sealing an end of the fuel cladding tube with an end plug. The fuel rods 31 are arranged in a regular matrix inside the fuel assembly 300 while being spaced apart from each other. An opening in an upper portion and an opening in a lower portion of the fuel rod 31 are sealed by end plugs in a state in which fuel pellets and a plenum spring are loaded inside the fuel cladding tube.

In FIGS. 3 and 4, as the fuel rods 31, a standard fuel rod 31a having a length extending over substantially the entire length of the fuel assembly 300 and a partial length fuel rod 31b having a length smaller than that of the standard fuel rod 31a are provided. The partial length fuel rod 31b is a fuel rod having an internal effective fuel length smaller than that of the standard fuel rod 31a and having a height not reaching the upper tie plate 34. An upper portion of the standard fuel rod 31a is supported by the upper tie plate 34 via a spring. Lower portions of the standard fuel rod 31a and the partial length fuel rod 31b are inserted into the lower tie plate 35. Intermediate portions of the standard fuel rod 31a and the partial length fuel rod 31b in the vertical direction are supported by the plurality of spacers 36.

The water rod 32 is a hollow tube, and is a component that supports the spacers 36 and adjusts the output, void fraction, and the like of the fuel assembly 300. The water rod 32 is arranged at a center of the plurality of fuel rods 31 arranged in a matrix, which is near a center of the channel box 33 in a top view. An upper portion of the water rod 32 is supported by the upper tie plate 34. A lower portion of the water rod 32 is supported by the lower tie plate 35. The plurality of spacers 36 are fixed to an intermediate portion of the water rod 32 in the vertical direction while being spaced apart from each other.

The channel box 33 is provided to surround the plurality of fuel rods 31 arranged in a matrix. The channel box 33 is provided in a tubular shape having a rectangular shape in a top view. The plurality of fuel rods 31 are bundled in parallel with each other and inserted into the channel box 33 so as to be arranged in a matrix in a top view. The channel box 33 is supported by a spring that supports upper portions of the fuel rods 31.

The upper tie plate 34 is a component that supports the upper portions of the fuel rods 31 and the upper portion of the water rod 32. Upper portions of the standard fuel rods 31a are supported by the upper tie plate 34 via a spring in a state of being spaced apart from each other. An upper portion of the water rod 32 is supported by the upper tie plate 34.

The lower tie plate 35 is a component that supports a lower portion of the fuel rod 31 and a lower portion of the water rod 32. A lower portion of the standard fuel rod 31a and a lower portion of the partial length fuel rod 31b are supported in a state in which the end plug is inserted into the lower tie plate 35, and the lower portions are spaced apart from each other. The lower portion of the water rod 32 is supported by the lower tie plate 35.

The spacer 36 is a component that supports an intermediate portion of the fuel rod 31 or the like in the vertical direction. The plurality of spacers 36 are arranged in the vertical direction while being spaced apart from each other. The spacer 36 is supported by the water rod 32. An intermediate portion of the standard fuel rod 31a in the vertical direction and an intermediate portion of the partial length fuel rod 31b in the vertical direction are bundled by the spacer 36 and supported in a state of being spaced apart from each other.

The handle 37 is a component for suspending the fuel assembly 300 by a crane or the like. The handle 37 is disposed above the upper tie plate 34. Both ends of the handle 37 are fixed to the upper tie plate 34.

In the fuel assembly 300 for the BWR, the coating layer 10 including the chromium layer 2 and the corrosion-resistant layer 3 and the coating layer 20 including the isolation layer 4, the chromium layer 2, and the corrosion-resistant layer 3 are preferably formed on an outer surface of the fuel cladding tube of the fuel rod 31, an outer surface of the end plug of the fuel rod 31, an outer surface of the water rod 32, or an inner surface or an inner surface and an outer surface of the channel box 33. The base material 1 with a surface on which the coating layer 10, 20 is formed is preferably a portion forming one or more of the fuel cladding tube of the fuel rod 31, the end plug of the fuel rod 31, the water rod 32, and the channel box 33.

The outer surface of the fuel cladding tube of the fuel rod 31, the outer surface of the end plug of the fuel rod 31, the outer surface of the water rod 32, and the inner surface and the outer surface of the channel box 33 are formed of a zirconium alloy, and are portions that are in contact with the cooling water 5 of the nuclear reactor. When the coating layer 10, 20 is formed on these portions, high oxidation resistance is obtained due to the chromium layer 2 in an accident environment. Further, in the operation environment, high corrosion resistance is obtained due to the corrosion-resistant layer 3. That is, it is possible to achieve both oxidation resistance at a high temperature during an accident of a nuclear reactor and corrosion resistance in a water environment where it is in contact with cooling water during normal operation of the nuclear reactor.

FIG. 5 longitudinal-sectional view showing an example of a fuel rod. FIG. 5 shows a structure of the fuel rod for a BWR. As shown in FIG. 5, the fuel rod 31 includes a fuel pellet 311, a fuel cladding tube 312, end plugs 313, and a plenum spring 314. As the end plugs 313, an upper portion end plug 313a for closing an upper opening of the fuel cladding tube 312 and a lower portion end plug 313b for closing a lower opening of the fuel cladding tube 312 are provided.

An upper portion side of the fuel rod 31 for the BWR is elastically supported by the upper tie plate 34, and a lower portion side thereof is inserted into and supported by the lower tie plate 35. The fuel pellet 311 is formed by molding a sintered body of nuclear fuel such as uranium oxide into a pellet shape. The upper portion end plug 313a and the lower portion end plug 313b are formed of a zirconium alloy in a plug shape. The plenum spring 314 is a spring interposed in the plenum on the upper portion side inside the fuel cladding tube 312.

The fuel pellets 311 are stacked and loaded inside the fuel cladding tube 312. The plenum spring 314 is interposed between the stacked fuel pellets 311 and the upper portion end plug 313a, and presses and fixes the fuel pellets 311 from above. An inert gas such as helium is sealed in the fuel cladding tube 312. The opening in the upper portion of the fuel cladding tube 312 is sealed by welding the upper portion end plug 313a. The opening in the lower portion of the fuel cladding tube 312 is sealed by welding the lower portion end plug 313b.

In the fuel rod 31 for the BWR, the coating layer 10 including the chromium layer 2 and the corrosion-resistant layer 3 and the coating layer 20 including the isolation layer 4, the chromium layer 2, and the corrosion-resistant layer 3 are preferably formed at least on the outer surface of the fuel cladding tube 312, and more preferably formed on the outer surface of the fuel cladding tube 312 and the outer surface of the end plug 313. The coating layer 10, 20 is preferably formed on both the outer surface of the upper portion end plug 313a and the outer surface of the lower portion end plug 313b.

An outer surface side of the fuel rod 31 is a portion that is exposed to a single-phase flow of the high-temperature water or a two-phase flow including high-temperature hot water or high-temperature water and steam, which is cooling water during normal operation of the nuclear reactor, and is a portion that is easily exposed to high-temperature steam during an accident of the nuclear reactor. When the coating layer 10, 20 is formed on these portions, it is possible to achieve both oxidation resistance at a high temperature during an accident of the nuclear reactor and corrosion resistance in a water environment during normal operation of the nuclear reactor. During an accident that occurs unexpectedly during normal operation, a sound chromium layer can be ensured on the surface of the fuel rod, and therefore, elution of zirconium forming the fuel rod and generation of hydrogen can be delayed.

FIG. 6 is a partial cross-sectional view showing an example of a water rod. FIG. 6 shows a partial cross section by cutting out a part of the water rod. As shown in FIG. 6, the water rod 32 includes a body portion 321, end plugs 322, a handle portion 323, and hole portions 324. As the end plug 322, an upper portion end plug 322a for closing an opening in an upper portion of the body portion 321 and a lower portion end plug 322b for closing an opening in a lower portion of the body portion 321 are provided.

The body portion 321 is formed of a zirconium alloy in a tubular shape. The upper portion end plug 322a and the lower portion end plug 322b are formed of a zirconium alloy in a plug shape. A plurality of hole portions 324 penetrating the inside and outside are formed in the body portion 321. The body portion 321 is designed such that the cooling water can flow into the body portion through the hole portion 324. The opening in the upper portion of the body portion 321 is sealed by welding the upper portion end plug 322a. The opening in the lower portion of the body portion 321 is sealed by welding the lower portion end plug 322b to the handle portion 323 joined to the lower portion of the body portion 321.

In the water rod 32, the coating layer 10 including the chromium layer 2 and the corrosion-resistant layer 3 and the coating layer 20 including the isolation layer 4, the chromium layer 2, and the corrosion-resistant layer 3 are preferably formed at least on an outer surface of the body portion 321, more preferably formed on the outer surface of the body portion 321 and an outer surface of the end plug 322, and still more preferably formed on the outer surface of the body portion 321, the outer surface of the end plug 322, an outer surface of the handle portion 323, and an inner surface of the hole portion 324. The coating layer 10, 20 is preferably formed on both the outer surface of the upper portion end plug 322a and the outer surface of the lower portion end plug 322b.

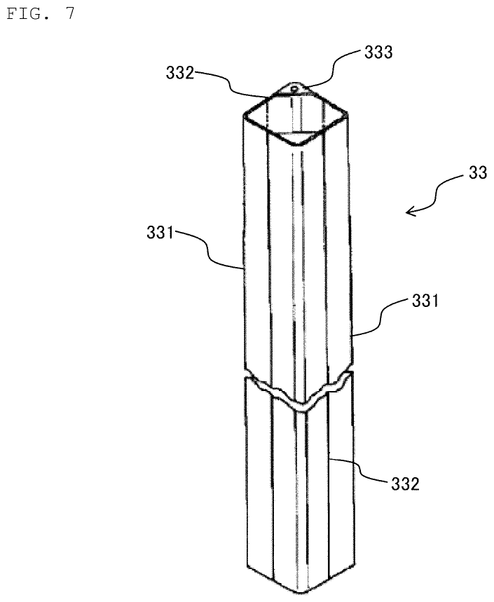

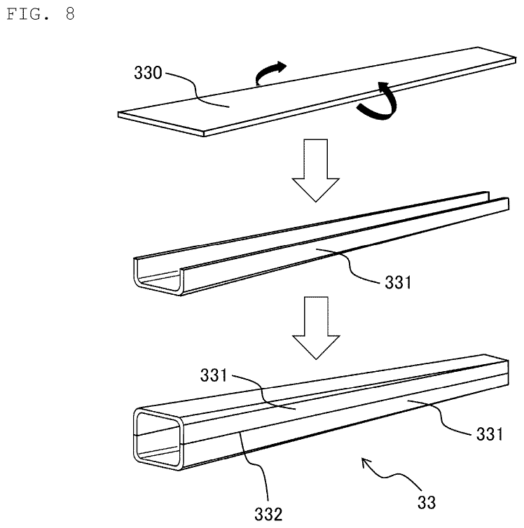

FIG. 7 is a perspective view showing an example of a channel box. FIG. 7 shows a structure of the channel box for a BWR. As shown in FIG. 7, the channel box 33 is formed in a rectangular tube shape having a square shape in a top view. The channel box 33 is formed by joining a pair of U-shaped members 331 having a U-shape in a cross-sectional view.

The U-shaped member 331 is formed of a zirconium alloy. The channel box 33 is provided in a structure in which two U-shaped members 331 are joined to each other via a joint portion 332 extending along a longitudinal direction through centers of both surfaces of the channel box 33. A flat plate-shaped clip 333 used to fix the channel box 33 to the fuel assembly is provided at a corner of an upper end of the channel box 33 so as to protrude inward.

In the channel box 33, the coating layer 10 including the chromium layer 2 and the corrosion-resistant layer 3 and the coating layer 20 including the isolation layer 4, the chromium layer 2, and the corrosion-resistant layer 3 are preferably formed at least on an inner surface of the U-shaped member 331, and more preferably formed on both the inner surface and an outer surface of the U-shaped member 331.

An inner surface side of the U-shaped member 331 is a portion that is likely to be exposed to high-temperature steam due to heat generation of the fuel rod during an accident of the nuclear reactor. It is possible to achieve both oxidation resistance at a high temperature during an accident of the nuclear reactor and corrosion resistance in a water environment during normal operation of the nuclear reactor. During an accident that occurs unexpectedly during normal operation, a sound chromium layer can be ensured on a surface of the channel box, and therefore, elution of zirconium forming the channel box and generation of hydrogen can be delayed.

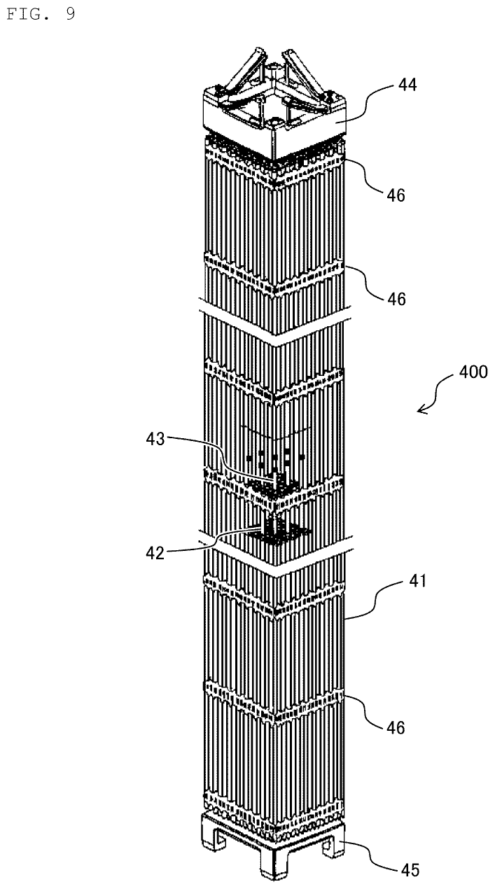

FIG. 8 is a diagram showing a method for producing the channel box. FIG. 8 shows a step of forming a channel box for a BWR by joining U-shaped members to each other. The upper part of FIG. 8 shows a plate material 330 which is a primarily processed material used as a material. The middle part of FIG. 8 shows the U-shaped member 331 which is a secondarily processed material obtained by performing bending processing on the plate material 330. The lower part of FIG. 8 shows the channel box 33 to which the U-shaped member 331 is joined.

As shown in FIG. 8, the channel box 33 can be produced by molding the plate material 330 to form the U-shaped member 331 and joining a pair of U-shaped members 331 to each other. As the plate material 330, a long flat plate formed of a zirconium alloy is prepared.

The U-shaped member 331 can be formed by molding the plate material 330 into a U-shape in which both end sides in a lateral direction are bent at a right angle in the same direction. The U-shaped member 331 is preferably molded by roll forming. This is because when the plate material 330 on which the coating layer 10, 20 is formed is subjected to bending processing, a crack may occur in the coating layer 10, 20.

Both end surfaces of the pair of U-shaped members 331 extending along the longitudinal direction can abut against each other and joined by welding. As a welding method, arc welding such as TIG welding or plasma welding, laser welding, electron beam welding, or the like can be used.

In the step of forming the channel box 33, the coating layer 10 including the chromium layer 2 and the corrosion-resistant layer 3 and the coating layer 20 including the isolation layer 4, the chromium layer 2, and the corrosion-resistant layer 3 are preferably formed after the plate material 330 serving as a base material is prepared and before the assembling in which the U-shaped members 331 are joined to each other. The coating layer 10, 20 can be formed on one surface or both surfaces of the plate material 330 in a flat plate state or one surface or both surfaces of the U-shaped member 331 in a state of being molded into a U-shape.

The channel box 33 is longer than 4 meters and has a structure in which the inner surface is less likely to be coated after assembly. In contrast, when the coating layer 10, 20 is formed on the plate material 330 or the U-shaped member 331 before assembling, the coating layer 10, 20 having high uniformity in composition and thickness can be formed on either surface or both surfaces.

After the assembling in which the U-shaped members 331 are joined to each other and before the channel box 33 is used, the local coating layer 10, 20 may be additionally formed on a surface of the joint portion 332 in which the U-shaped members 331 are joined to each other. The surface of the weld metal that is easily corroded can be coated with the coating layer 10, 20 by using a thermal spraying method, a cold spraying method, or the like.

FIG. 9 is a perspective view showing an example of a fuel assembly for a PWR. FIG. 9 schematically shows a structure including a central portion by seeing through a part of the fuel assembly for the PWR. As shown in FIG. 9, a fuel assembly 400 for the PWR includes a plurality of fuel rods 41, control guiding thimbles 42, in-core instrumentation guiding rod thimbles 43, an upper nozzle 44, a lower nozzle 45, and support lattices 46.

The fuel assembly 400 is a structure in which a plurality of fuel rods 41 are bundled, and is loaded in a reactor core of a pressurized water reactor (PWR). In the PWR, a control rod cluster including a plurality of control rods is inserted into the large fuel assembly 400 so as to be movable in the vertical direction. The fuel rods and the control rods are arranged in a matrix in a lattice-shaped space inside the fuel assembly 400.

The fuel rod 41 is formed by filling a fuel cladding tube with fuel pellets obtained by molding nuclear fuel. The fuel rods 41 are arranged in a regular matrix inside the fuel assembly 400 while being spaced apart from each other. An opening in an upper portion and an opening in a lower portion of the fuel rod 41 are sealed by the end plugs in a state in which the fuel rod 41 is filled with the fuel pellets or the plenum spring.

The control rod guiding thimble 42 is a hollow tube that guides insertion of a control rod. The control rod guiding thimbles 42 are intermittently arranged in the lattice-shaped space inside the fuel assembly 400, and are regularly aligned with a plurality of fuel rods. The control rod is movably inserted into the control rod guiding thimble 42 in the vertical direction.

The in-core instrumentation guiding thimble 43 is a hollow tube that guides insertion of in-core instrumentation devices such as a neutron detector. The in-core instrumentation guiding thimbles 43 are arranged at a center of the lattice-shaped space inside the fuel assembly 400 and aligned with the plurality of fuel rods. A thimble incorporating an in-core instrumentation device is inserted into the in-core instrumentation guiding thimble 43 from the outside of the reactor.

The upper nozzle 44 is arranged above the plurality of fuel rods 41, and forms a framework that supports the fuel rods 41 and the like. The upper nozzle 44 has a function of ensuring a flow path for the cooling material and is also used for positioning and conveying the fuel assembly 400. The upper nozzle 44 supports an upper portion of the control rod guiding thimble 42 and an upper portion of the in-core instrumentation guiding thimble 43.

The lower nozzle 45 is arranged below the plurality of fuel rods 41, and forms a framework that supports the fuel rods 41 and the like. The lower nozzle 45 has a function of ensuring a flow path for the cooling material and is also used for controlling the flow of the cooling material. The lower nozzle 45 supports a lower portion of the control rod guiding thimble 42 and a lower portion of the in-core instrumentation guiding thimble 43.

The support lattices 46 are a component that forms a lattice-shaped space into which the fuel rods 41 and the like are inserted, and bundles and supports the fuel rods 41 and the like, and are arranged at intermediate portions of the plurality of fuel rods 41 in the vertical direction to form a framework that supports the fuel rods 41 and the like. The plurality of support lattices 46 are arranged along the vertical direction of the fuel assembly 400 while being spaced apart from each other. The support lattice 46 is supported by the control rod guiding thimble 42 and holds the plurality of fuel rods 41 and the like in a state of being bundled and spaced apart from each other.

The fuel rods 41 are individually inserted into lattice-shaped spaces formed by the support lattices 46. An upper portion, a lower portion, and an intermediate portion in the vertical direction of the fuel rod 41 are supported by a protrusion, a plate spring, or the like formed on the support lattice 46. An upper portion of the control rod guiding thimble 42 is supported by the upper nozzle 44. A lower portion of the control rod guiding thimble 42 is supported by the lower nozzle 45. A plurality of support lattices 46 are supported at an intermediate portion of the control rod guiding thimble 42 in the vertical direction.

In the fuel assembly 400 for the PWR, the coating layer 10 including the chromium layer 2 and the corrosion-resistant layer 3 and the coating layer 20 including the isolation layer 4, the chromium layer 2, and the corrosion-resistant layer 3 are preferably formed on an outer surface of the fuel cladding tube of the fuel rod 41, an outer surface of the end plug of the fuel rod 41, an outer surface of the control rod guiding thimble 42, an outer surface of the in-core instrumentation guiding thimble 43, and an outer surface of the support lattice 46 formed of zirconium. The base material 1 with a surface on which the coating layer 10, 20 is formed is preferably a portion that forms one or more of the fuel cladding tube of the fuel rod 41, the end plug of the fuel rod 41, the control rod guiding thimble 42, the in-core instrumentation guiding thimble 43, and the support lattice 46.

The outer surface of the fuel cladding tube of the fuel rod 41, the outer surface of the end plug of the fuel rod 41, the outer surface of the control rod guiding thimble 42, the outer surface of the in-core instrumentation guiding thimble 43, and the outer surface of the support lattice 46 are formed of a zirconium alloy, and are portions in contact with the cooling water 5 of the nuclear reactor. When the coating layer 10, 20 is formed on these portions, high oxidation resistance is obtained due to the chromium layer 2 in an accident environment. Further, in the operation environment, high corrosion resistance is obtained due to the corrosion-resistant layer 3. That is, it is possible to achieve both oxidation resistance at a high temperature during an accident of a nuclear reactor and corrosion resistance in a water environment where it is in contact with cooling water during normal operation of the nuclear reactor.

Although the embodiments of the invention have been described above, the invention is not limited to the above-described embodiments, and various modifications can be made without departing from the gist of the invention. For example, the invention is not necessarily limited to the one including all the configurations included in the above-described embodiment. A part of a configuration of an embodiment may be replaced with configuration, a part of the another configuration of the embodiment may be added to another configuration, or a part of the configuration of the embodiment may be omitted.

### Examples

The invention will be specifically described below with reference to Examples, but the technical scope of the invention is not limited to Examples.

### (1) Evaluation of Coating Structure

A test piece obtained by coating a base material formed of zircaloy-2 with a chromium layer and a corrosion-resistant layer in this order and a test piece obtained by additionally coating the base material with an isolation layer were produced and subjected to a corrosion test and an oxidation test to evaluate corrosion resistance and oxidation resistance of a coating structure.

When the corrosion-resistant layer was formed of a zirconium alloy, the chromium layer and the corrosion-resistant layer were formed by a thin plate cladding method. When the corrosion-resistant layer was formed of a titanium alloy, the chromium layer and the corrosion-resistant layer were formed according to a physical vapor deposition method or a thin plate cladding method.

The corrosion test was performed by immersing the test piece on which the coating structure was formed in high-temperature and high-pressure pure water for 500 hours. The test conditions were 290° C., about 70 atm, and a dissolved oxygen concentration of 8 mg/L. The oxidation test was performed by heating the test piece on which the coating structure was formed in steam at atmospheric pressure, and exposing the test piece for 1 minute after reaching a predetermined temperature. The test temperature was 1200° C. or 1350° C.

The corrosion test and the oxidation test were performed by changing a composition and a thickness of each layer constituting the coating structure. The results of the corrosion test were evaluated based on the presence or absence of weight loss due to corrosion of the test piece. The results of the oxidation test were evaluated by observing an interface of each layer with a microscope for the presence or absence of melting due to oxidation of the test piece.

### Table 1

TABLE 1

| | | | | Weight | | | |
|---|---|---|---|---|---|---|---|
| | Coating structure | | | loss in | Melting in | Melting in | |
| | Isolation | Chromium | Corrosion- | corrosion | oxidation test | oxidation test | |
| No. | layer | layer | resistant layer | test | at 1200° C. | at 1350° C. | Positioning |
| 1 | — | Cr 10 μm | — | Yes | No | Base | Comparison |
| | | | | | | material/chromium | |
| | | | | | | layer interface | |
| 2 | — | Cr 10 μm | Zry-2 10 μm | No | No | Base | Invention |
| | | | | | | material/chromium | |
| | | | | | | layer interface | |
| | | | | | | Chromium | |
| | | | | | | layer/corrosion- | |
| | | | | | | resistant layer | |
| | | | | | | interface | |
| 3 | — | Cr 10 μm | Cr—Ti slope 2 μm | No | No | Base | Invention |
| | | | Ti 3 μm | | | material/chromium | |
| | | | | | | layer interface | |
| 4 | Nb 5 μm | Cr 10 μm | Zry-2 10 μm | No | No | Chromium | Invention |
| | | | | | | layer/corrosion- | |
| | | | | | | resistant layer | |
| | | | | | | interface | |
| 5 | Ti 5 μm | Cr 10 μm | Zry-2 10 μm | No | No | Chromium | Invention |
| | | | | | | layer/corrosion- | |
| | | | | | | resistant layer | |
| | | | | | | interface | |
| 6 | Nb 1 μm | Cr 5 μm | Cr—Ti slope 3 μm | No | No | No | Invention |
| | Nb—Cr slope 2 μm | | Ti 3 μm | | | | |
| 7 | Nb 3 μm | Cr 10 μm | Ti 5 μm | No | No | No | Invention |
| 8 | Ti 1 μm | Cr 5 μm | Cr—Ti slope 2 μm | No | No | No | Invention |
| | Ti—Cr slope 2 μm | | Ti 3 μm | | | | |
| 9 | Nb 20 μm | Cr 20 μm | Ti 10 μm | No | No | No | Invention |
| 10 | Ti 10 μm | Cr 20 μm | Ti 10 μm | No | No | No | Invention |

Table 1 is a table showing evaluation results of the corrosion test and the oxidation test. Table 1 shows a composition and a thickness of each layer constituting a coating structure of each prepared test piece, results of the corrosion test and results of the oxidation test of each test piece.

No. 1 is a test piece obtained by coating a base material with only a chromium layer. The thickness of the chromium layer was 10 μm.

In No. 1, the weight loss of the coating layer was confirmed in the corrosion test in which the base material was exposed to a high-temperature and high-pressure water environment. It is considered that chromium was eluted from the chromium layer. In addition, in the oxidation test in which the base material was exposed to a steam environment at 1200° C., melting was not confirmed. It is considered that an oxide film of chromium oxide having excellent oxidation resistance at a high temperature was formed on a surface of the chromium layer. In the oxidation test in which the base material was exposed to a steam environment at 1350° C., an oxide film of chromium oxide remained. However, a trace of melting was confirmed at an interface between the base material and the chromium layer.

No. 2 is a test piece obtained by coating a base material with a chromium layer and a corrosion-resistant layer. The thickness of the chromium layer was 10 μm. The corrosion-resistant layer was formed of only a zirconium alloy layer made of zircaloy-2. The thickness of the corrosion-resistant layer was 10 μm.

In No. 2, the weight loss of the coating layer was not confirmed in the corrosion test in which the base material was exposed to a high-temperature and high-pressure water environment. It is considered that the corrosion resistance was improved by the corrosion-resistant layer, and the chromium layer was protected. In addition, in the oxidation test in which the base material was exposed to a steam environment at 1200° C., melting was not confirmed. It is considered that an oxide film made of zirconium oxide or chromium oxide, which has excellent oxidation resistance at a high temperature, was formed on a surface of the corrosion-resistant layer or a surface of the chromium layer. However, in the oxidation test in which the base material was exposed to a steam environment at 1350° C., an oxide film made of zirconium oxide or chromium oxide remained, but a trace of melting was confirmed at an interface between the base material and the chromium layer or an interface between the chromium layer and the corrosion-resistant layer.

No. 3 is a test piece obtained by coating a base material with a chromium layer and a corrosion-resistant layer. The thickness of the chromium layer was 10 μm. The corrosion-resistant layer was formed as a two-layer structure of a compositionally graded layer having a concentration gradient from pure chromium to pure titanium and a titanium layer made of pure titanium. The thickness of the compositionally graded layer was 2 μm. The thickness of the titanium layer was 3 μm.

In No. 3, the weight loss of the coating layer was not confirmed in the corrosion test in which the base material was exposed to a high-temperature and high-pressure water environment. It is considered that the corrosion resistance was improved by the corrosion-resistant layer, and the chromium layer was protected. In addition, in the oxidation test in which the base material was exposed to a steam environment at 1200° C., melting was not confirmed. It is considered that an oxide film made of titanium oxide or chromium oxide, which has excellent oxidation resistance at a high temperature, was formed on a surface of the corrosion-resistant layer or a surface of the chromium layer. However, in the oxidation test in which the base material was exposed to a steam environment at 1350° C., an oxide film made of titanium oxide or chromium oxide remained, but a trace of melting was confirmed at an interface between the base material and the chromium layer. It can be said that the formation of the corrosion-resistant layer prevented a reaction and melting at an interface between the chromium layer and the corrosion-resistant layer.

No. 4 is a test piece obtained by coating a base material with an isolation layer, a chromium layer, and a corrosion-resistant layer. The isolation layer was formed of only a niobium layer made of niobium. The thickness of the isolation layer was 5 μm. The thickness of the chromium layer was 10 μm. The corrosion-resistant layer was formed of only a zirconium alloy layer made of zircaloy-2. The thickness of the corrosion-resistant layer was 10 μm.

No. 5 is a test piece obtained by coating a base material with an isolation layer, a chromium layer, and a corrosion-resistant layer. The isolation layer was formed of only a titanium layer made of titanium. The thickness of the isolation layer was 5 μm. The thickness of the chromium layer was 10 μm. The corrosion-resistant layer was formed of only a zirconium alloy layer made of zircaloy-2. The thickness of the corrosion-resistant layer was 10 μm.

In No. 4 and No. 5, the weight loss of the coating layer was not confirmed in the corrosion test in which the base material was exposed to a high-temperature and high-pressure water environment. It is considered that the corrosion resistance was improved by the corrosion-resistant layer, and the chromium layer was protected. In addition, in the oxidation test in which the base material was exposed to a steam environment at 1200° C., melting was not confirmed. It is considered that an oxide film made of zirconium oxide, titanium oxide, or chromium oxide, which has excellent oxidation resistance, was formed on a surface of the corrosion-resistant layer or a surface of the chromium layer. However, in the oxidation test in which the base material was exposed to a pure steam environment at 1350° C., an oxide film of zirconium oxide, titanium oxide, or chromium oxide remained, but a trace of melting was confirmed at an interface between the chromium layer and the corrosion-resistant layer. It can be said that the formation of the isolation layer prevented the reaction and melting at an interface between the base material and the chromium layer.

No. 6 is a test piece obtained by coating a base material with an isolation layer, a chromium layer, and a corrosion-resistant layer. The isolation layer was formed as a two-layer structure of a niobium layer made of pure niobium and a compositionally graded layer having a concentration gradient from pure niobium to pure chromium. The thickness of the niobium layer was 1 μm. The thickness of the compositionally graded layer was 2 μm. The thickness of the chromium layer was 5 μm. The corrosion-resistant layer was formed as a two-layer structure of a compositionally graded layer having a concentration gradient from pure chromium to pure titanium and a titanium layer made of pure titanium. The thickness of the compositionally graded layer was 3 μm. The thickness of the titanium layer was 3 μm.

No. 7 is a test piece obtained by coating a base material with an isolation layer, a chromium layer, and a corrosion-resistant layer. The isolation layer was formed of only a niobium layer made of niobium. The thickness of the isolation layer was 3 μm. The thickness of the chromium layer was 10 μm. The corrosion-resistant layer was formed of only a titanium layer made of titanium. The thickness of the corrosion-resistant layer was 5 μm.

No. 8 is a test piece obtained by coating a base material with an isolation layer, a chromium layer, and a corrosion-resistant layer. The isolation layer was formed as a two-layer structure of a titanium layer made of pure titanium and a compositionally graded layer having a concentration gradient from pure titanium to pure chromium. The thickness of the titanium layer was 1 μm. The thickness of the compositionally graded layer was 2 μm. The thickness of the chromium layer was 5 μm. The corrosion-resistant layer was formed as a two-layer structure of a compositionally graded layer having a concentration gradient from pure chromium to pure titanium and a titanium layer made of pure titanium. The thickness of the compositionally graded layer was 2 μm. The thickness of the titanium layer was 3 μm.

No. 9 is a test piece obtained by coating a base material with an isolation layer, a chromium layer, and a corrosion-resistant layer. The isolation layer was formed of only a niobium layer made of niobium. The thickness of the isolation layer was 20 μm. The thickness of the chromium layer was 20 μm. The corrosion-resistant layer was formed of only a titanium layer made of titanium. The thickness of the corrosion-resistant layer was 10 μm.

No. 10 is a test piece obtained by coating a base material with an isolation layer, a chromium layer, and a corrosion-resistant layer. The isolation layer was formed of only a titanium layer made of titanium. The thickness of the isolation layer was 10 μm. The thickness of the chromium layer was 20 μm. The corrosion-resistant layer was formed of only a titanium layer made of titanium. The thickness of the corrosion-resistant layer was 10 μm.

In No. 6 and No. 10, the weight loss of the coating layer was not confirmed in the corrosion test in which the base material was exposed to a high-temperature and high-pressure water environment. It is considered that the corrosion resistance was improved by the corrosion-resistant layer, and the chromium layer was protected. In addition, in the oxidation test in which the base material was exposed to a steam environment at 1200° C., melting was not confirmed. It is considered that an oxide film made of titanium oxide or chromium oxide, which has excellent oxidation resistance, was formed on a surface of the corrosion-resistant layer or a surface of the chromium layer. In addition, in the oxidation test in which the base material was exposed to a steam environment at 1350° C., melting was not confirmed. It can be said that the formation of the corrosion-resistant layer and the isolation layer prevented the reaction and melting at an interface between the chromium layer and the corrosion-resistant layer and an interface between the base material and the chromium layer.

In No. 2 to No. 10, when the corrosion-resistant layer is formed of a zirconium alloy, a ratio of the atomic concentration of zirconium to the atomic concentration of chromium in the entire chromium layer and corrosion-resistant layer is 3/2 or less. When the corrosion-resistant layer is formed of a titanium alloy, a ratio of the atomic concentration of titanium to the atomic concentration of chromium in the entire chromium layer and corrosion-resistant layer is 1 or less. Therefore, no disappearance of the chromium layer due to melting was observed even at a high temperature of 1200° C. to 1350° C.

During an accident of the nuclear reactor, the high temperature in the reactor may become higher than 1200° C. due to decay heat of nuclear fuel or the like. In a steam environment at high temperature exceeding 1200° C., an oxidation rate of metal and a diffusion rate of atoms are high, and therefore, the oxidation of the entire material forming the fuel assembly progresses, and the chemical composition is averaged. However, the chromium layer formed on the surface of the base material functions as a protective film that increases oxidation resistance at a high temperature, and therefore, it is expected to prevent rapid oxidation of the zirconium alloy, temperature rise of the zirconium alloy due to reaction heat of the oxidation reaction, and generation of hydrogen due to a reaction between the zirconium alloy and steam. In addition, the corrosion-resistant layer formed on the surface of the chromium layer protects the chromium layer from corrosion during normal operation until an accident of the nuclear reactor occurs, and therefore, it is expected that a protective film that functions during an accident is ensured.

### (2) Production of Fuel Rod

A production example of a standard fuel rod in which a coating layer is formed on a base material formed of a zirconium alloy is shown. A water rod and a partial length fuel rod can be produced according to the method for producing the standard fuel rod. The coating layer is formed on an outer surface of a fuel cladding tube, an outer surface of an upper portion end plug, and an outer surface of a lower portion end plug. The coating layer can also be formed on an outer surface of the fuel cladding tube to which the lower portion end plug is joined or an outer surface of the lower portion end plug joined to the fuel cladding tube.

First, coating layers were formed on the outer surface of the fuel cladding tube, the outer surface of the upper portion end plug, and the outer surface of the lower portion end plug. The thickness of the base material forming the fuel cladding tube was 0.8 mm. The total thickness of the coating layer was 8 μm to 25 μm, the thickness of the chromium layer was 5 μm to 15 μm, and the thickness of the corrosion-resistant layer was 5 μm to 10 μm. When the isolation layer was formed, the thickness of the isolation layer was set to 1 μm to 5 μm. The thickness of the chromium layer was 1/31 or less of the thickness of the base material. When the corrosion-resistant layer was formed of a zirconium alloy, the ratio of the atomic concentration of zirconium to the atomic concentration of chromium in the entire chromium layer and corrosion-resistant layer was 3/2 or less. When the corrosion-resistant layer was formed of a titanium alloy, the ratio of the atomic concentration of titanium to the atomic concentration of chromium in the entire chromium layer and corrosion-resistant layer was set to 1 or less.

A vicinity of a joint portion between the fuel cladding tube and the lower portion end plug and a vicinity of a joint portion between the fuel cladding tube and the upper portion end plug were masked in advance before joining. This is because diffusion of atoms and melting of each layer may proceed when the coating layer is heated during welding of the joint portion. When the coating layer was formed according to a thermal spraying method or a cold spraying method, the surface was polished and flattened after coating such that each layer had a predetermined thickness. When the coating layer was formed according to a physical vapor deposition method, the coating layer was subjected to heat treatment after coating in order to increase adhesion between the layers.

Subsequently, the lower portion end plug was joined to a lower portion of the fuel cladding tube. Then, fuel pellets and a plenum spring were loaded inside the fuel cladding tube, and the upper portion end plug was joined to an upper portion of the fuel cladding tube in a helium gas atmosphere adjusted to a predetermined pressure. After the lower portion end plug and the upper portion end plug were joined to each other, a joint portion was subjected to a non-destructive inspection with ultrasonic waves to confirm that there was no defect in the joint portion. In a vicinity of the joint portion, the zirconium alloy was exposed by masking. However, an area proportion of the joint portion to the entire surface of the fuel rod is small, and therefore, the fuel rod can be used even when the zirconium alloy is exposed. However, a local coating layer may also be additionally formed in the vicinity of the joint portion. The coating layer may also be applied to the fuel cladding tube and the lower portion end plug after the lower portion end plug is joined to the lower portion of the fuel cladding tube. In this case, only the vicinity of the joint portion between the fuel cladding tube and the upper portion end plug is masked in advance before joining.

### (3) Production of Channel Box

A production example of a channel box in which a coating layer is formed on a base material formed of a zirconium alloy is shown. The coating layer is formed on an inner surface of a U-shaped member or an outer surface of the U-shaped member. A plate material and the U-shaped member used for producing the channel box have a thickness of about 3 mm and are thicker than the fuel cladding tube. Therefore, a thick coating layer can be formed as compared with the case of the fuel cladding tube. In addition, unlike the case of the fuel cladding tube, the layer can be formed on a planar portion, and therefore, a layer having high thickness uniformity can be formed.

First, a long rectangular-shaped plate material formed of a zirconium alloy was prepared. A metal plate having a predetermined composition and thickness for forming a chromium layer and a metal plate having a predetermined composition and thickness for forming a corrosion-resistant layer were laminated in this order on the prepared plate material, and then the laminate was subjected to hot rolling to form a coating layer. When an isolation layer was to be formed, a metal plate having a predetermined composition and thickness for forming the isolation layer was laminated under the metal plate for forming the chromium layer. Then, the laminate was formed into a U-shape by hot roll forming to produce a U-shaped member. In addition, another plate material was used to form a coating layer according to a physical vapor deposition method, a thermal spraying method, or a cold spraying method to produce the U-shaped member.

When the corrosion-resistant layer is formed of a zirconium alloy, it is required to appropriately control a chemical composition of the zirconium alloy in forming an oxide film having high protection properties on the surface of the corrosion-resistant layer. When the corrosion-resistant layer is formed using the physical vapor deposition method, the thermal spraying method, or the cold spraying method, a difference in chemical composition is likely to occur between the material used for the coating and the formed corrosion-resistant layer, and thus it is difficult to control the chemical composition of the zirconium alloy. In contrast, when the thin plate cladding method is used, a thin plate having a chemical composition adjusted in advance can be used, and therefore, the chemical composition can be easily controlled. In addition, a dense layer can be formed as compared with a thermal spraying method or a cold spraying method in which pores are easily formed in the layer.

Subsequently, both ends of the U-shaped member abutted against each other and were joined to each other by plasma welding. After the U-shaped members were joined to each other, the joint portion was subjected to a non-destructive inspection with ultrasonic waves to confirm that there was no defect in the joint portion. A weld metal of the zirconium alloy was exposed in a vicinity of the joint portion. However, the area proportion of the joint portion in the entire surface of the channel box is small, and therefore, the channel box can be used even when the zirconium alloy is exposed. However, a local coating layer may also be additionally formed in the vicinity of the joint portion.

The channel box after the joining was subjected to quenching and annealing using high-frequency induction heating for the purpose of controlling a material structure. Then, shaping for matching the dimensions and polishing for removing the oxide film were performed. The corrosion-resistant layer was thickly applied in advance on the assumption of thinning using polishing. Subsequently, a clip was joined to an end of the channel box by welding. Then, the outer surface of the channel box was cleaned, and a dense oxide film was formed on the outer surface in high-temperature steam pressurized to a high pressure. Thereafter, components such as a channel spacer were attached to an outer surface of the channel box to complete the channel box.

### (4) Results of Evaluation and Production

As described above, it was confirmed that when the coating layer including the chromium layer and the corrosion-resistant layer or the coating layer including the isolation layer, the chromium layer, and the corrosion-resistant layer is formed on the base material formed of a zirconium alloy forming the fuel assembly, high oxidation resistance at a high temperature is obtained by the chromium layer, and high corrosion resistance during normal operation is obtained by the corrosion-resistant layer. It was confirmed that a target coating layer can be formed by performing coating before assembling during production of f the fuel rod or during production of the channel box. It was shown that it is possible to reduce the deterioration in the coating structure and the load on the purification system during normal operation while ensuring the soundness of the fuel assembly during an accident of a nuclear reactor.

### REFERENCE SIGNS LIST

1: base material
2: chromium layer
3: corrosion-resistant layer
3a: oxide film
4: isolation layer
5: cooling water
10: coating layer
20: coating layer
100: coating structure
200: coating structure

1. A fuel assembly for a water-cooled reactor, the fuel assembly comprising:
a base material formed of a zirconium alloy; and
a coating layer formed on the base material, wherein
the coating layer includes
a chromium layer formed of chromium or a chromium alloy on a surface of the base material that would otherwise be in contact with cooling water, and
a corrosion-resistant layer formed of a zirconium alloy or a titanium alloy on a surface of the chromium layer.

2. The fuel assembly according to claim 1, wherein
the coating layer includes an isolation layer formed of niobium or titanium between the base material and the chromium layer.

3. The fuel assembly according to claim 1, wherein
the coating layer includes an oxide film on a surface of the corrosion-resistant layer to be in contact with the cooling water.

4. The fuel assembly according to claim 1, wherein
the base material is formed of a zirconium alloy containing one or more alloy elements of niobium, tin, iron, chromium, and nickel at a concentration of 3 mass % or less, with the balance being zirconium and inevitable impurities,
the chromium layer contains one or more of niobium, tin, iron, chromium, nickel, zirconium, titanium, and inevitable impurities diffused from a layer adjacent to the chromium layer, and
the corrosion-resistant layer contains one or more of niobium, tin, iron, chromium, nickel, zirconium, titanium, and inevitable impurities diffused from a layer adjacent to the corrosion-resistant layer.

5. The fuel assembly according to claim 4, wherein
the corrosion-resistant layer has a region containing chromium diffused from the chromium layer at a concentration of 3 mass % or more.

6. The fuel assembly according to claim 2, wherein
the isolation layer contains one or more of niobium, tin, iron, chromium, nickel, zirconium, titanium, and inevitable impurities diffused from a layer adjacent to the isolation layer.

7. The fuel assembly according to claim 1, wherein
a thickness of the chromium layer is 5 μm or more and 1/31 or less of a thickness of the base material.

8. The fuel assembly according to claim 1, wherein
a thickness of the corrosion-resistant layer is 5 μm or more, and
in the coating layer, a ratio of an atomic concentration of zirconium to an atomic concentration of chromium is 3/2 or less when the corrosion-resistant layer is formed of a zirconium alloy, and a ratio of an atomic concentration of titanium to an atomic concentration of chromium is 1 or less when the corrosion-resistant layer is formed of a titanium alloy.

9. The fuel assembly according to claim 2, wherein
a thickness of the isolation layer is 1 μm or more and 20 μm or less.

10. The fuel assembly according to claim 1, further comprising:
a plurality of fuel rods each obtained by loading fuel pellets in a fuel cladding tube and being sealed by end plugs;
a water rod disposed at a center of a plurality of the fuel rods;
a channel box surrounding a periphery of the plurality of fuel rods;
an upper tie plate supporting upper portions of the fuel rods in a state of being spaced apart from each other;
a lower tie plate supporting lower portions of the fuel rods in a state of being spaced apart from each other; and
a plurality of spacers supporting intermediate portions of the fuel rods in a state of being spaced apart from each other, wherein
the base material is a portion forming one or more of the fuel cladding tube, the end plugs, the water rod, and the channel box, and
the coating layer is formed on an outer surface of the fuel cladding tube, an outer surface of the end plug, an outer surface of the water rod, or an inner surface or an inner surface and an outer surface of the channel box.

11. The fuel assembly according to claim 1, further comprising:
a plurality of fuel rods each obtained by loading fuel pellets in a fuel cladding tube and being sealed by end plugs;
a control rod guiding thimble aligned with the fuel rods and guiding insertion of a control rod;
an in-core instrumentation guiding thimble aligned with the fuel rods and guiding insertion of an in-core measurement device;
an upper nozzle disposed above the fuel rods and forming a framework that supports the fuel rods;
a lower nozzle disposed below the fuel rods and forming a framework that supports the fuel rods; and
a plurality of support lattices disposed in an intermediate portion of the fuel rods and forming a framework that supports the fuel rods, wherein
the base material is a portion forming one or more of the fuel cladding tube, the end plugs, the control rod guiding thimble, the in-core instrumentation guiding thimble, and the support lattice, and
the coating layer is formed on an outer surface of the fuel cladding tube, an outer surface of the end plug, an outer surface of the control rod guiding thimble, an outer surface of the in-core instrumentation guiding thimble, or an outer surface of the support lattice.

12. A method for producing a fuel assembly for a water-cooled reactor, the method comprising:
a step of preparing a base material formed of a zirconium alloy;
a step of forming a chromium layer by chromium or a chromium alloy on a surface of the base material that would otherwise be in contact with cooling water;
a step of forming a corrosion-resistant layer by a zirconium alloy or a titanium alloy on a surface of the chromium layer; and
a step of assembling the fuel assembly using the base material, wherein
the chromium layer and the corrosion-resistant layer are formed according to a thin plate cladding method in which thin plates are stacked and diffusion-joined, a physical vapor deposition method, a thermal spraying method, a cold spraying method, or a plating method before the assembling using the base material.

13. The method for producing a fuel assembly according to claim 12, further comprising:
before the step of forming the chromium layer, a step of forming an isolation layer by niobium or titanium on the surface of the base material to be in contact with the cooling water, wherein
the isolation layer is formed according to a thin plate cladding method in which thin plates are stacked and diffusion-joined, a physical vapor deposition method, a thermal spraying method, or a cold spraying method before the assembling using the base material.

14. The method for producing a fuel assembly according to claim 12, further comprising:
a step of forming an oxide film on a surface of the corrosion-resistant layer to be in contact with the cooling water, wherein
the oxide film is formed by exposing the corrosion-resistant layer to high-temperature water or high-temperature steam after the assembling using the base material and before using the fuel assembly.
